(19) United States
(12) Patent Application Publication
(10) Pub. No.: US 2026/0209023 A1
(43) Pub. Date: Jul. 23, 2026

(54) BEVERAGE DISPENSER WITH FLAVOR INGREDIENT MIXING CHAMBER

(71) Applicant: THE COCA-COLA COMPANY, Atlanta, GA (US)

(72) Inventors: Andrew KOLPITCKE, Atlanta, GA (US); Shriya PATEL, Atlanta, GA (US); Brian B. JOHNSON, Atlanta, GA (US)

(21) Appl. No.: 19/139,013

(22) PCT Filed: Dec. 20, 2023
(86) PCT No.: PCT/US2023/085139

§ 371 Date: Jun. 13, 2025

Related U.S. Application Data
(60) Provisional application No. 63/434,705, filed on Dec. 22, 2022.

(51) Int. Cl. B67D 1/00

(52) U.S. Cl. CPC B67D 1/0037

(57) ABSTRACT

Various implementations include a beverage dispenser including a bulk ingredient flow path, a mixing chamber, and a dispenser nozzle. The mixing chamber includes an inlet on a first end of the mixing chamber coupled to the bulk ingredient flow path. The mixing chamber further includes an outlet on a second end of the mixing chamber opposite to the first end. The mixing chamber further includes a sidewall defining a mixing chamber flow path through the mixing chamber from the first end to the second end. In some implementations, a plurality of flavor ingredient nozzles are positioned on the sidewall and adapted to dispense fractional drops of flavor ingredients in the mixing chamber flow path. The dispenser nozzle includes a first inlet coupled to the bulk ingredient flow path and a second inlet coupled to the outlet of the mixing chamber.

### CROSS-REFERENCE TO RELATED APPLICATIONS

This application claims priority to U.S. Provisional Patent Application No. 63/434,705, filed Dec. 22, 2022, which is incorporated herein by reference in its entirety.

### BACKGROUND

Traditional post-mix beverage dispensing systems generally mix streams of syrup, concentrate, sweetener, bonus flavors, other types of flavorings, and/or other ingredients with water or other types of diluents by flowing the syrup stream down the center of the nozzle with the water stream flowing around the outside. The syrup stream is directed downward with the water stream such that the streams mix as they fall into a consumer's cup. There is a desire for a beverage dispensing system as a whole to provide as many different types and flavors of beverages as may be possible in a footprint that may be as small as possible. Recent improvements in beverage dispensing technology have focused on the use of micro-ingredients. With micro-ingredients, the traditional beverage bases may be separated into their constituent parts at much higher dilution or reconstitution ratios.

This technology is enabled via cartridges containing the highly concentrated micro-ingredients. The micro-ingredients are mixed with sweeteners and still or sparkling water using precise metering and dosing technologies and dispensed through a nozzle that promotes in-air mixing so as to prevent carry-over. The technology includes a user input for a user to select a desired beverage, customize the beverage if desired, and pour the beverage at the dispenser. These beverages are made from precise recipes to ensure a great tasting beverage regardless of the customization.

### SUMMARY

Various implementations include a beverage dispenser including a bulk ingredient flow path, a mixing chamber, and a dispenser nozzle. The mixing chamber includes an inlet on a first end of the mixing chamber coupled to the bulk ingredient flow path. The mixing chamber further includes an outlet on a second end of the mixing chamber opposite to the first end. The mixing chamber further includes a sidewall defining a mixing chamber flow path through the mixing chamber from the first end to the second end. In some implementations, a plurality of flavor ingredient nozzles are positioned on the sidewall and adapted to dispense fractional drops of flavor ingredients in the mixing chamber flow path. The dispenser nozzle includes a first inlet coupled to the bulk ingredient flow path and a second inlet coupled to the outlet of the mixing chamber.

In some implementations, the plurality of flavor ingredient nozzles are positioned on the sidewall such that a flow of fluid through the mixing chamber flow path washes over the plurality of flavor ingredient nozzles. In some implementations, the mixing chamber comprises a static mixer positioned in the mixing chamber flow path. In some implementations, the dispenser nozzle further comprises a plurality of micro-ingredient inlets and one or more macro-ingredient inlets.

In some implementations, the bulk ingredient flow path is a carbonated or still water flow path. In some implementations, the bulk ingredient flow path is a sweetener flow path.

In some implementations, the beverage dispenser further includes a flavor ingredient flow path coupled to each of the plurality of flavor ingredient nozzles. In some implementations, each flavor ingredient flow path includes a check valve. In some implementations, the check valve is positioned at an outlet of the corresponding flavor ingredient nozzle.

In some implementations, the beverage dispenser further includes a flavor ingredient source coupled to each of the plurality of flavor ingredient nozzles. In some implementations, the flavor ingredient comprises flavor ingredients with reconstitution ratios greater than 300:1.

In some implementations, the beverage dispenser further includes an ingredient storage chamber selectively coupled between the outlet of the mixing chamber and the second inlet of the dispenser nozzle. In some implementations, the beverage dispenser further includes a plurality of ingredient storage chambers. In some implementations, each ingredient storage chamber is selectively coupled between the outlet of the mixing chamber and the second inlet of the dispenser nozzle. In some implementations, the ingredient storage chamber is one of the plurality of ingredient storage chambers.

Various other implementations include a method of dispensing a beverage. The method includes flowing a bulk beverage ingredient along a flow path of a mixing chamber, dispensing an amount including a fractional drop of flavor ingredient from each of a plurality of flavor ingredient nozzles positioned along the flow path in a sidewall of the mixing chamber to produce a mixed flavor ingredient, dispensing the mixed flavor ingredient from a dispenser nozzle coupled to the mixing chamber, and dispensing the bulk beverage ingredient from the dispenser nozzle.

In some implementations, the amount of flavor ingredient dispensed from one of the plurality of flavor ingredient nozzles is different than the amount of flavor ingredient dispensed from another of the plurality of flavor ingredient nozzles. In some implementations, the bulk beverage ingredient washes over the plurality of flavor ingredient nozzles.

In some implementations, the method further includes dispensing one or more micro-ingredient and/or one or more macro-ingredient beverage ingredients from the dispenser nozzle. In some implementations, the bulk ingredient is carbonated or still water. In some implementations, each of the flavor ingredient nozzles is positioned on a flavor ingredient flow path. In some implementations, each flavor ingredient flow path includes a check valve. In some implementations, the check valve is positioned at an outlet of the corresponding flavor ingredient nozzle.

In some implementations, a flavor ingredient source is coupled to each of the plurality of flavor ingredient flow paths. In some implementations, the flavor ingredient has a reconstitution ratios greater than 300:1.

These and other features will be more clearly understood from the following detailed description taken in conjunction with the accompanying drawings and claims.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is an exemplary block diagram showing a beverage dispenser.

FIG. 2 is an exemplary block diagram showing a beverage dispenser.

FIG. 3 illustrates an exemplary beverage dispenser system suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents. Use of the phrase “and/or” indicates that any one or any combination of a list of options can be used. For example, “A”, “B”, and/or “C” means “A”, or “B”, or “C”, or “A and B”, or “A and C”, or “A and B and C”.

Recent improvements in beverage dispensing technology have focused on the use of molecular ingredients. With molecular ingredients, an array of molecules may be combined into a single composition representing a particular flavor or beverage ingredient.

Described herein are example systems and methods for controlling a blended sweetener flow in a beverage dispensing system (such as a Coca-Cola® Freestyle®, traditional fountain dispenser, or traditional fountain dispenser with micro-ingredients). For example, a beverage dispensing system (which may include one or more macro-ingredients and one or more micro-ingredients and one or more molecular ingredients) combines macro-ingredients (such as sweeteners, water, or carbonated water) and micro-ingredients (such as high intensity sweeteners, flavorings, food acids, or additives) and molecular ingredients (such as individual molecules or mixtures that by themselves are not a beverage flavor, but form the base components of a flavor profile such that, when mixed with other molecular ingredients, the molecular ingredients form a beverage flavor or beverage ingredient) to create a finished beverage. Such micro-dosing functionality may increase the dispensing capabilities of the beverage dispensing system to deliver a large variety of beverages and improve the quality of the beverage dispensed by the beverage dispensing system. The use of molecular ingredients further expands the number of flavors and variety of beverages that are able to be dispensed.

Generally described, the macro-ingredients may have reconstitution ratios in the range from full strength (no dilution) to about six (6) to one (1) (but generally less than about ten (10) to one (1)). As used herein, the reconstitution ratio refers to the ratio of diluent (e.g., water or carbonated water) to beverage ingredient. Therefore, a macro-ingredient with a 5:1 reconstitution ratio refers to a macro-ingredient that is to be dispensed and mixed with five parts diluent for every part of the macro-ingredient in the finished beverage. Many macro-ingredients may have reconstitution ratios in the range of about 3:1 to 5.5:1, including 4.5:1, 4.75:1, 5:1, 5.25:1, 5.5:1, and 8:1 reconstitution ratios.

The macro-ingredients may include sweeteners such as sugar syrup, HFCS (“High Fructose Corn Syrup”), FIS (“Fully Inverted Sugar”), MIS (“Medium Inverted Sugar”), mid-calorie sweeteners comprised of nutritive and non-nutritive or high intensity sweetener blends, and other such nutritive sweeteners that are difficult to pump and accurately meter at concentrations greater than about 10:1-particularly after having been cooled to standard beverage dispensing temperatures of around 35-45° F. An erythritol sweetener may also be considered a macro-ingredient sweetener when used as the primary sweetener source for a beverage, though typically erythritol will be blended with other sweetener sources and used in solutions with higher reconstitution ratios such that it may be considered a micro-ingredient as described below.

The macro-ingredients may also include traditional BIB (“bag-in-box”) flavored syrups (e.g., COCA-COLA bag-in-box syrup) which contain all of a finished beverage's sweetener, flavors, and acids that when dispensed is to be mixed with a diluent source such as plain or carbonated water in ratios of around 3:1 to 6:1 of diluent to the syrup. Other typical macro-ingredients may include concentrated extracts, purees, juice concentrates, dairy products or concentrates, soy concentrates, and rice concentrates.

The macro-ingredient may also include macro-ingredient base products. Such macro-ingredient base products may include the sweetener as well as some common flavorings, acids, and other common components of a plurality of different finished beverages. However, one or more additional beverage ingredients (either micro-ingredients or macro-ingredients as described herein) other than the diluent are to be dispensed and mix with the macro-ingredient base product to produce a particular finished beverage. In other words, the macro-ingredient base product may be dispensed and mixed with a first micro-ingredient non-sweetener flavor component to produce a first finished beverage. The same macro-ingredient base product may be dispensed and mixed with a second micro-ingredient non-sweetener flavor component to produce a second finished beverage. The same macro-ingredient base product may be dispensed and mixed with one or more molecular ingredients and/or one or more micro-ingredients to produce a finished beverage.

The macro-ingredients described above may be stored in a conventional bag-in-box container in, at and/or remote from the dispenser. The viscosity of the macro-ingredients may range from about 1 to about 10,000 centipoise and generally over 100 centipoises or so when chilled. Other types of macro-ingredients may be used herein.

The micro-ingredients may have reconstitution ratios ranging from about ten (10) to one (1) and higher. Specifically, many micro-ingredients may have reconstitution ratios in the range of about 20:1, to 50:1, to 100:1, or up to 300:1. The viscosities of the micro-ingredients typically range from about one (1) to about six (6) centipoise or so, but may vary from this range. In some instances, the viscosities of the micro-ingredients may be forty (40) centipoise or less. Examples of micro-ingredients include natural or artificial flavors; flavor additives; natural or artificial colors; artificial sweeteners (high potency, nonnutritive, or otherwise); antifoam agents, nonnutritive ingredients, additives for controlling tartness, e.g., citric acid or potassium citrate; functional additives such as vitamins, minerals, herbal extracts, nutraceuticals; and over the counter (or otherwise) medicines such as pseudoephedrine, acetaminophen; and similar types of ingredients. Various acids may be used in micro-ingredients including food acid concentrates such as phosphoric acid, citric acid, malic acid, or any other such common food acids. Various types of alcohols may be used as either macro-or micro-ingredients. The micro-ingredients may be in liquid, gaseous, or powder form (and/or combinations thereof including soluble and suspended ingredients in a variety of media, including water, organic solvents, and oils). Other types of micro-ingredients may be used herein.

Typically, micro-ingredients for a finished beverage product include separately stored non-sweetener beverage component concentrates that constitute the flavor components of the finished beverage. Non-sweetener beverage component concentrates do not act as a primary sweetener source for the finished beverage and do not contain added sweeteners, though some non-sweetener beverage component concentrates may have sweet tasting flavor components or flavor components that are perceived as sweet in them. These non-sweetener beverage component concentrates may include the food acid concentrate and food acid-degradable (or non-acid) concentrate components of the flavor, such as described in commonly owned U.S. patent application Ser. No. 11/276,553, entitled “Methods and Apparatus for Making Compositions Comprising and Acid and Acid Degradable Component and/or Compositions Comprising a Plurality of Selectable Components,” which is herein incorporated by reference in its entirety. As noted above, micro-ingredients may have reconstitution ratios ranging from about ten (10) to one (1) and higher, where the micro-ingredients for the separately stored non-sweetener beverage component concentrates that constitute the flavor components of the finished beverage typically have reconstitution ratios ranging from 50:1, 75:1, 100:1, 150:1, or up to 300:1.

For example, the non-sweetener flavor components of a cola finished beverage may be provided from separately stored first non-sweetener beverage component concentrate and a second non-sweetener beverage component concentrate. The first non-sweetener beverage component concentrate may comprise the food acid concentrate components of the cola finished beverage, such as phosphoric acid. The second non-sweetener beverage component concentrate may comprise the food acid-degradable concentrate components of the cola finished beverage, such as flavor oils that would react with and impact the taste and shelf life of a non-sweetener beverage component concentrate were they to be stored with the phosphoric acid or other food acid concentrate components separately stored in the first non-sweetener component concentrate. While the second non-sweetener beverage component concentrate does not include the food acid concentrate components of the first non-sweetener beverage component concentrate (e.g., phosphoric acid), the second non-sweetener beverage component concentrate may still be a high-acid beverage component solution (e.g., pH less than 4.6).

A finished beverage may have a plurality of non-sweetener concentrate components of the flavor other than the acid concentrate component of the finished beverage. For example, the non-sweetener flavor components of a cherry cola finished beverage may be provided from the separately stored non-sweetener beverage component concentrates described in the above example as well as a cherry non-sweetener component concentrate. The cherry non-sweetener component concentrate may be dispensed in an amount consistent with a recipe for the cherry cola finished beverage. Such a recipe may have more, less, or the same amount of the cherry non-sweetener component concentrate than other recipes for other finished beverages that include the cherry non-sweetener component concentrate. For example, the amount of cherry specified in the recipe for a cherry cola finished beverage may be more than the amount of cherry specified in the recipe for a cherry lemon-lime finished beverage to provide an optimal taste profile for each of the finished beverage versions. Such recipe-based flavor versions of finished beverages are to be contrasted with the addition of flavor additives or flavor shots as described below.

Other typical micro-ingredients for a finished beverage product may include micro-ingredient sweeteners. Micro-ingredient sweeteners may include high intensity sweeteners such as aspartame, Ace-K, steviol glycosides (e.g., Reb A, Reb M), sucralose, saccharin, or combinations thereof. Micro-ingredient sweeteners may also include erythritol when dispensed in combination with one or more other sweetener sources or when using blends of erythritol and one or more high intensity sweeteners as a single sweetener source.

Other typical micro-ingredients for supplementing a finished beverage product may include micro-ingredient flavor additives. Micro-ingredient flavor additives may include additional flavor options that can be added to a base beverage flavor. The micro-ingredient flavor additives may be non-sweetener beverage component concentrates. For example, a base beverage may be a cola flavored beverage, whereas cherry, lime, lemon, orange, and the like may be added to the cola beverage as flavor additives, sometimes referred to as flavor shots. In contrast to recipe-based flavor versions of finished beverages, the amount of micro-ingredient flavor additive added to supplement a finished beverage may be consistent among different finished beverages. For example, the amount of cherry non-sweetener component concentrate included as a flavor additive or flavor shot in a cola finished beverage may be the same as the amount of cherry non-sweetener component concentrate included as a flavor additive or flavor shot in a lemon-lime finished beverage. Additionally, whereas a recipe-based flavor version of a finished beverage is selectable via a single finished beverage selection icon or button (e.g., cherry cola icon/button), a flavor additive or flavor shot is a supplemental selection in addition to the finished beverage selection icon or button (e.g., cola icon/button selection followed by a cherry icon/button selection).

Molecular ingredients include individual chemicals or molecules that are combined together to create one or more specific flavors or other beverage ingredients. Sets of the molecular ingredients may be loaded into the beverage dispenser 100. By using predefined recipes of two or more molecular ingredients, the beverage dispenser 100 may create one or more mixtures for use as a flavor or other beverage ingredient in a particular beverage. Each mixture is created at a specific volume and concentration for each desired beverage.

For example, a molecular ingredient may include a carrier and natural flavorings. In some implementations, the carrier is citric acid. Each natural flavoring can be broken down into base chemicals and combined in a wide variety of flavor profiles. By utilizing a number of molecular ingredients, a larger number of combinations and permutations of molecular ingredients are possible. The result is a large number of flavor profiles and beverages, providing greater flexibility to the overall beverage dispenser. A greater number of beverages may be produced than the total number of molecular ingredients provided in the beverage dispenser.

Each mixture is created by adding small quantities of a variety of individual molecular ingredients (e.g., two or more molecular ingredients). For example, each molecular ingredient that is added to create a flavor or beverage ingredient mixture is dispensed in an amount of a fractional drops. For example, a fractional drop is an amount of fluid that is less than an amount needed to create a full drop (e.g., an amount between 0 and 1 drop). Therefore, the fractional drop is held by surface tension to a nozzle or other dispensing port. It is contemplated that a fractional drop may also include some fractional amount above a whole number of drops (e.g., an amount between two other whole numbers, e.g., between 1 and 2 drops, between, 2 and 3 drops, etc.). In some implementations, the fractional drops of molecular ingredients are dispensed at a volume of 0.05 mL or less. In some implementations, the fractional drops of molecular ingredients are dispensed at volumes in the range of nanoliters or picoliters.

A molecular ingredient may be a flavor ingredient with a reconstitution ratio greater than 300:1. In some implementations, a molecular ingredient includes flavor ingredients with a reconstitution ratio of greater than 900:1 (e.g., 1200:1 or 1500:1). Molecular ingredients may include a variety of viscosities, wherein a given viscosity will affect the reconstitution ratio and/or the volume of the fraction drop of the molecular drop dispensed for a given dispensing action.

As is generally understood, beverage selections may be made through a touchscreen user interface (not shown) or other typical beverage user interface selection mechanism (e.g., buttons) on a beverage dispenser. The selected beverage, including any selected flavor additives, may then be dispensed upon the beverage dispenser receiving a further dispense command through a separate dispense button on the touchscreen user interface or through interaction with a separate pour mechanism such as a pour button (electromechanical, capacitive touch, or otherwise) or pour lever.

In operation, the beverage dispenser may dispense finished beverages from any one or more of the macro-ingredient sources, micro-ingredient sources, and molecular ingredient sources/packages described above. For example, similar to the traditional BIB flavored syrup delivery of a finished beverage, a macro-ingredient flavored syrup may be dispensed with a diluent source such as plain or carbonated water to produce a finished beverage. Additionally, the traditional BIB flavored syrup may be dispensed with the diluent and one or more micro-ingredient or mixture of molecular ingredient flavor additives to increase the variety of beverages offered by the beverage dispenser.

Micro-ingredient-based finished beverages may be dispensed by separately dispensing each of two or more non-sweetener beverage component concentrates of the finished beverage (e.g., acid and acid-degradable non-sweetener beverage component concentrates) along with a sweetener and diluent. The sweetener may be a macro-ingredient sweetener and/or a micro-ingredient sweetener and the diluent may be water and/or carbonated water.

For example, a micro-ingredient-based cola finished beverage may be dispensed by separately dispensing food acid concentrate components of the cola finished beverage, such as phosphoric acid, food acid-degradable concentrate components of the cola finished beverage, such as flavor oils, macro-ingredient sweetener, such as HFCS, and carbonated water. In another example, a micro-ingredient-based diet-cola finished beverage may be dispensed by separately dispensing food acid concentrate components of the diet-cola finished beverage, food acid-degradable concentrate components of the diet-cola finished beverage, micro-ingredient sweetener, such as aspartame or an aspartame blend, and carbonated water.

As a further example, a mid-calorie micro-ingredient-based cola finished beverage may be dispensed by separately dispensing food acid concentrate components of the mid-calorie cola finished beverage, food acid-degradable concentrate components of the mid-calorie cola finished beverage, a reduced amount of a macro-ingredient sweetener, a reduced amount of a micro-ingredient sweetener, and carbonated water. By reduced amount of macro-ingredient and micro-ingredient sweeteners, it is meant to be in comparison with the amount of macro-ingredient or micro-ingredient sweetener used in the cola finished beverage and diet-cola finished beverage.

As a further example, a supplemental flavored micro-ingredient-based beverage, such as a cherry cola beverage or a cola beverage with an orange flavor shot, may be dispensed by separately dispensing a food acid concentrate components of the flavored cola finished beverage, food acid-degradable concentrate components of the flavored cola finished beverage, one or more non-sweetener micro-ingredient flavor additives (dispensed as either as a recipe-based flavor version of a finished beverage or a flavor shot), a sweetener (macro-ingredient sweetener, micro-ingredient sweetener, or combinations thereof), and carbonated water. While the above examples are provided for carbonated beverages, they apply to still beverages as well by substituting carbonated water with plain water.

As a final example, a supplemental flavored molecular ingredient-based beverage, such as a cherry cola beverage or a cola beverage with an orange flavor shot, may be dispensed by separately dispensing a variety of specific combinations of molecular ingredients. Combinations of molecular ingredients may be dispensed and mixed with a bulk beverage ingredient (e.g., carbonated water) to form one or more of: a food acid concentrate components of the flavored soda finished beverage, food acid-degradable concentrate components of the flavored cola finished beverage (e.g., cherry or orange flavor), one or more non-sweetener flavor additives (dispensed as either as a recipe-based flavor version of a finished beverage or a flavor shot), or a sweetener. Each of the above examples of ingredients may be formed by molecular ingredients, or one or more may be formed from molecular ingredients while others are formed from micro-ingredients or macro-ingredients. Overall, a combination of molecular, micro-, and macro-ingredients provide for a wide array of combinations which can be specifically tuned for each beverage requested. While the above examples are provided for carbonated beverages, they apply to still beverages as well by substituting carbonated water with plain water.

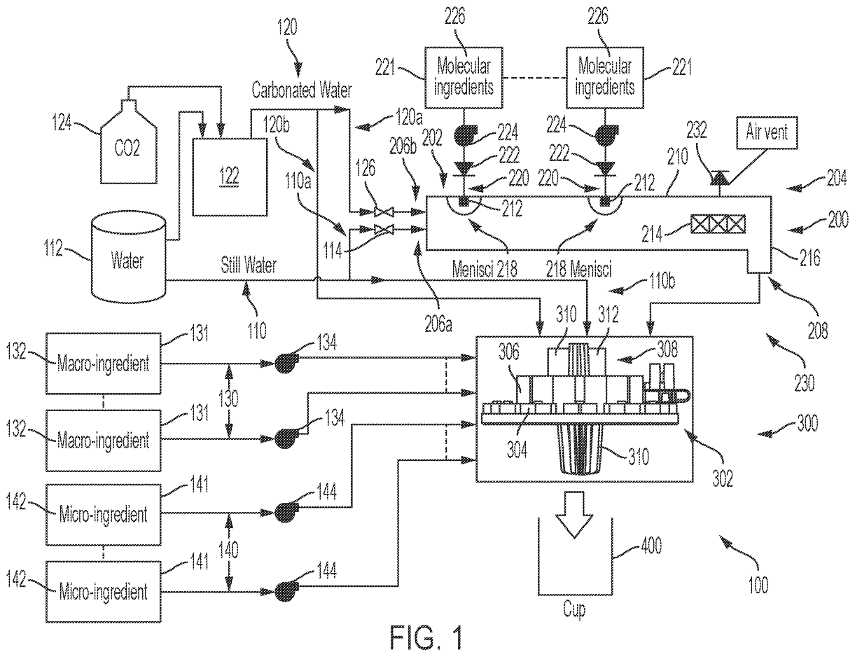

FIG. 1 shows a beverage dispenser 100, according to one implementation. The beverage dispenser 100 a plurality of ingredient flow paths, a mixing chamber 200, and a dispenser nozzle 300.

As shown in FIG. 1, the beverage dispenser 100 includes a still water flow path 110 (which, in some implementations, may be considered a bulk ingredient flow path) including a still water source 112. In some implementations, the still water source 112 is a municipal water supply.

The still water flow path 110 includes a mixing chamber branch 110a and a nozzle branch 110b. The still water source 112 is in fluid communication with the mixing chamber 200 via the mixing chamber branch 110a. The mixing chamber branch 110a includes a shutoff valve 114 disposed between the still water source 112 and the mixing chamber 200.

The still water flow path 110, and the still water source 112, are in fluid communication with the dispenser nozzle 300 via the nozzle branch 110b. Other components, such as a flow meter, proportional valve, and a shut-off valve (not shown) may also be present along the nozzle branch 110b for controlling the flow of still water to the dispenser nozzle 300.

The still water source 112 is in fluid communication with a carbonated water source 122, such as a carbonator. The carbonated water source 122 is also in fluid communication with a CO₂ source 124. The carbonated water source 122 is configured to combine still water and CO₂ such that carbonated water flows out of the carbonated water source 122 along a carbonated water flow path 120. As shown in FIG. 1, beverage dispenser 100 includes a carbonated water flow path 120 (which, in some implementations, may be considered a bulk ingredient flow path).

The carbonated water flow path 120 includes a mixing chamber branch 120a and a nozzle branch 120b. The carbonated water flow path 120 is in fluid communication with mixing chamber 200 via the mixing chamber branch 120a and the dispenser nozzle 300 via the nozzle branch 120b. The carbonated water flow path 120 includes a shutoff valve 126 disposed between the CO₂ source 124 and the mixing chamber 200.

The carbonated water flow path 120, and the carbonated water source 122, are in fluid communication with the dispenser nozzle 300 via the nozzle branch 120b. Other components, such as a flow meter, proportional valve, and a shut-off valve (not shown) may also be present along the nozzle branch 120b for controlling the flow of carbonated water to the dispenser nozzle 300.

The beverage dispenser 100 further includes a plurality of macro-ingredients packages 131 each containing a macro-ingredient 132. Each macro-ingredient package 131 is coupled to macro-ingredient flow paths 130, thus allowing macro-ingredients 132 to be in fluid communication with the beverage dispenser 100. A pump 134 is positioned along each of the macro-ingredient flow paths 130 and configured to supply a macro-ingredient 132 from a respective one of the plurality of macro-ingredients packages 131 to the dispenser nozzle 300. In some implementations, the macro-ingredient flow paths 130 may additionally include a metering valve and/or a shutoff valve disposed between the macro-ingredient package 131 and the dispenser nozzle 300.

In some implementations, one or more of the plurality of macro-ingredients 132 includes a sweetener. In some implementations, one or more of the macro-ingredient flow paths 130 may be considered a bulk ingredient flow path. In some implementations, one of the macro-ingredient flow paths 130 is for a sweetener macro-ingredient and includes a branch to the mixing chamber 200 and a branch to the dispenser nozzle 300 (not shown). As such, each of the implementations described herein with respect to mixing of a bulk ingredient in the mixing chamber 200 may likewise be performed with a macro-ingredient sweetener.

The beverage dispenser 100 further includes a plurality of micro-ingredient packages 141 each containing a micro-ingredient 142. Each micro-ingredient package 141 is coupled to micro-ingredient flow paths 140, thus allowing micro-ingredients 142 to be in fluid communication with the beverage dispenser 100. As shown in FIG. 1, a pump 144 is positioned along each of the micro-ingredient flow paths 140 and configured to supply a micro-ingredient 142 from a respective one of the plurality of micro-ingredients packages 141 to the dispenser nozzle 300. In some implementations, one or more of the plurality of micro-ingredients 142 includes a sweetener.

The mixing chamber 200 includes a first end 202, a second end 204, a still water inlet 206a, a carbonated water inlet 206b, an outlet 208, a sidewall 210, a plurality of flavor ingredient nozzles 212, and a static mixer 214. The second end 204 of the mixing chamber 200 is opposite and spaced apart from the first end 202. The first end 202 of the mixing chamber 200 has the still water inlet 206a and the carbonated water inlet 206b, each of which are in fluid communication with the still water flow path 110 and the carbonated water flow path 120, respectively. Specifically, the still water mixing chamber branch 110a and the carbonated water mixing chamber branch 120a are in fluid communication with the still water inlet 206a and the carbonated water inlet 206b, respectively. The outlet 208 is disposed on the second end 204 of the mixing chamber 200. The sidewall 210 defines a mixing chamber flow path 216 through the mixing chamber from the first end 202 to the second end 204. The sidewall 210 is shown with a rectangular cross-section, though any geometry (e.g., cylindrical, etc.) may be used for forming the sidewall 210 and correspondingly forming the geometry of the flow path 216.

The plurality of flavor ingredient nozzles 212 are positioned on the sidewall 210 and adapted to dispense fractional drops 218 of molecular ingredients 226 in the mixing chamber flow path 216. Each molecular ingredient 226 is disposed within molecular ingredient packages 221. Each molecular ingredient package 221 is coupled to and in fluid communication with the mixing chamber 200 via the molecular ingredient flow path 220. In the example shown, because the flavor ingredient nozzles 212 dispense fractional ingredients, a meniscus is formed around the respective flavor ingredient nozzles 212 due to the surface tension of the liquid. In some implementations, the plurality of flavor ingredient nozzles 212 are positioned on the sidewall 210 such that fluid flow through the mixing chamber 200 washes over the plurality of flavor ingredient nozzles 212. For example, still or carbonated water (or other bulk ingredient) flows through the flow path 216 and washes over the flavor ingredient nozzles 212 to wash away the meniscus of molecular ingredient formed around any of the flavor ingredient nozzles 212.

In some implementations, a molecular ingredient flow path 220 is coupled to each of the plurality of flavor ingredient nozzles 212. Each molecular ingredient flow path 220 includes a check valve 222 positioned at an outlet of the corresponding flavor ingredient nozzle 212. In some implementations, the flavor ingredient nozzles 212 have an inside diameter of less than 0.03 inches.

In some implementations, each of the plurality of molecular ingredient flow paths 220 includes a pump 224 in fluid communication with the respective molecular ingredient packages 221. While the pump 224 is shown as positioned on the molecular ingredient flow paths 220, other dosing mechanisms are contemplated by this disclosure. For example, the molecular ingredients 226 may be packaged in a syringe where the molecular ingredients are dosed by application of force to a plunger, such as by a solenoid, screw, piston, or other such mechanism. As such, the pump 224 is merely representative of the mechanism for dosing molecular ingredients 226 from the molecular ingredient packages 221. In some implementations, one or more pumps 224 may be used in conjunction with each other and may take advantage of the Venturi effect to pump a molecular ingredient 226 into the flavor ingredient nozzle 212.

In another example, the molecular ingredients 226 may be dosed via a piezoelectric element in fluid communication with the molecular ingredient package 221 and molecular ingredient flow path 220. Small doses, or fractional drops, of molecular ingredients 226 can be dispensed by activation of the piezoelectric elements.

In another example, the molecular ingredients 226 may be positioned within a pressure chamber that is pressurized by the CO₂ source 124. In this example, the pump 224 may be replaced with a shut-off valve that is configured to open and close for predetermined amounts of time to dose the molecular ingredients 226. Due to the pressure from the pressure chamber, the molecular ingredients 226 may be forced out of desired ones of the flavor ingredient nozzles 212 upon the shut-off valve opening. In some implementations, the check valve 222 may not be used when a shut-off valve is used.

In another example, molecular ingredients 226 may be packaged in a Lab-on-Chip device (“LOC Device”). The LOC device may be configured to hold a plurality of molecular ingredients 226 at once with corresponding valves, actuators, and flow paths. The LOC device may be configured to dose small volumes of a selected molecular ingredient 226 into the molecular ingredient flow path 220 or directly into the flavor ingredient nozzle 212. In some implementations, the LOC device may be combined with a rotary membrane valve pump (RMVP) to selectively move and dispense molecular ingredients 226.

In some implementations, a molecular ingredient package 221 is in fluid communication with each of the plurality of flavor ingredient nozzles 212. In some implementations, the molecular ingredient package 221 includes molecular ingredients 226, such as those described above, with a reconstitution ratio of greater than 300:1. In some implementations, the molecular ingredient package 221 includes molecular ingredients with a reconstitution ratio of greater than 900:1 (e.g., 1200:1 or 1500:1). In some implementations, the fractional drops 218 of molecular ingredients 226 are dispensed at a volume of 0.05 mL or less. In some implementations, the fractional drops 218 of molecular ingredients 226 are dispensed at volumes in the range of nanoliters or picoliters.

The mixing chamber 200 includes a static mixer 214 positioned in the mixing chamber flow path 216. The use of the static mixer 214 promotes good mixing of the bulk ingredient (e.g., still or carbonated water) with the plurality of dispensed molecular ingredients 226 from two or more of the molecular ingredient packages 221. In some implementations, the static mixer 214 may not be present. Regardless, the mixture of the bulk ingredient with the plurality of dispensed molecular ingredients 226 from two or more of the molecular ingredient packages 221 produces a mixed flavor ingredient.

In use, a bulk beverage ingredient flows along the flow path 216 of the mixing chamber 200. In some implementations, the bulk ingredient is carbonated or still water. In some implementations, the bulk ingredient is a macro-ingredient 132, for example a sweetener, or other macro-ingredient 132.

The mixing chamber 200 may include a vent 232 configured to allow fluid communication between the mixing chamber 200 and surrounding air. In some implementations, the beverage dispenser 100 shown in FIG. 1 is configured for batch dispensing. In batch dispensing, the bulk ingredient and molecular ingredients 226 are mixed within the mixing chamber 200 at a certain volume, and then that volume is dispensed from the nozzle 300. The vent 232 is used to drain the mixing chamber 200 when the volume of mixed molecular ingredients (e.g., mixed flavor ingredient) is dispensed. For example, after the bulk ingredient mixes with the molecular ingredients 226, the vent 232 may be opened to allow the mixing chamber 200 to drain to the nozzle 300. By draining the mixing chamber 200 between dispensing operations, carry over of ingredients between dispensing operations may be prevented.

In operation, the mixing chamber 200 may undergo a pre-wetting and post-flushing operation. In the pre-wetting operation, the flow path 216 of the mixing chamber 200 is filled with a bulk ingredient (e.g., carbonated or still water) prior to dispensing any of the molecular ingredients 226 from the flavor ingredient nozzles 212. Likewise, after completion of dispensing of molecular ingredients 226, a volume of the bulk ingredient (e.g., carbonated or still water) is flowed through the flow path 216 to wash off the flow path 216 and the flavor ingredient nozzles 212 to prevent carry over of molecular ingredients 226 from one dispensing operation to the next.

In some implementations, the mixing chamber 200 may additionally undergo a purge operation to purge any ingredients from the mixing chamber 200. For example, the CO₂ source 124 may be coupled to an inlet of the mixing chamber 200 via a shut-off valve (not shown). Following a dispensing operation or following the post-wash described above, CO₂ may be injected into the mixing chamber 200 to clear out and/or dry the flow path 216 and ensure all of the mixed flavor ingredient from the mixing chamber 200 are dispensed from the nozzle 300.

An amount is dispensed, including a fractional drop 218 of molecular ingredient 226 from two or more of the plurality of flavor ingredient nozzles 212 positioned in the sidewall 210 along the mixing chamber flow path 216 to produce a mixed flavor ingredient. The fractional drop 218 is less than a drop or a fractional amount between whole numbers of drops (e.g., between 1 and 2 drops, between 2 and 3 drops, etc.). In some implementations, the amount of molecular ingredient 226 dispensed from one of the plurality of flavor ingredient nozzles 212 is different than the amount of molecular ingredient 226 dispensed from another of the plurality of flavor ingredient nozzles 212.

The mixed flavor ingredient is dispensed from the outlet 208 of the mixing chamber 200. The outlet 208 is in fluid communication with a mixed flavor ingredient flow path 230 between the mixing chamber 200 and the nozzle 300. In some implementations, the mixed flavor ingredient flow path 230 may include one or more of a pump, a shut-off valve, a check valve, or other fluidic components (not shown) for controlling a flow of mixed flavor ingredient from the mixing chamber 200 to the nozzle 300. In some implementations, the post-wash and/or purge operation of the mixing chamber 200 controls the flow of the mixed flavor ingredient from the mixing chamber 200 to the nozzle 300.

The dispenser nozzle 300 includes a plurality of inlets and outlets for receiving and dispensing macro-ingredients 132, micro-ingredients 142, and mixed flavor ingredient from the mixing chamber 200. Example nozzles suitable for dispensing of such macro-ingredients, micro-ingredients, and mixed flavor ingredient include those described in commonly owned U.S. provisional patent application Ser. No. 62/433,886, entitled “Dispensing Nozzle Assembly,” PCT patent application Ser. No. PCT/US15/026657, entitled “Common Dispensing Nozzle Assembly,” U.S. Pat. No. 7,866,509, entitled “Dispensing Nozzle Assembly,” or U.S. Pat. No. 7,578,415, entitled “Dispensing Nozzle Assembly,” which are all herein incorporated by reference in their entirety.

The dispenser nozzle 300 includes a plurality of inlets and ports in fluid communication with various flow paths of the beverage dispenser 100. Each port or inlet, or system of inlets, is configured to allow the flow of still water, carbonated water, macro-ingredients, micro-ingredients, or mixed flavor ingredient.

The dispenser nozzle 300 may include an injector ring assembly 302 for receiving and dispensing micro-ingredients and macro-ingredients. The injector ring assembly includes a number of micro-ingredient inlets 304, a number of micro-ingredient outlets (not shown), and a micro-ingredient flow path (not shown) between each of the micro-ingredient inlets to a corresponding one of the micro-ingredient outlets. Likewise, the injector ring assembly includes a number of macro-ingredient inlets 306, a number of macro-ingredient outlets, and a macro-ingredient path between each of the macro-ingredient inlets to a corresponding set of the macro-ingredient outlets.

Each of the micro-ingredient flow paths 140 is fluidically coupled to a corresponding one of the plurality of micro-ingredient inlets 304 of the dispenser nozzle 300. Each of the macro-ingredient flow paths 130 is fluidically coupled to a corresponding one of the macro-ingredient inlets 306 of the dispenser nozzle. Additionally, the mixed flavor ingredient flow path 230 is coupled to one of the plurality of micro-ingredient inlets 304 or one of the macro-ingredient inlets 306 depending on the viscosity of the mixed flavor ingredient and the bulk ingredient used in the mixing chamber 200. For example, with a carbonated water or still water bulk ingredient, the mixed flavor ingredient flow path 230 is coupled to one of the plurality of micro-ingredient inlets 304. With a macro-ingredient sweetener bulk ingredient, the mixed flavor ingredient flow path 230 is coupled to one of the plurality of macro-ingredient inlets 306.

The dispenser nozzle 300 also has a core module assembly 308 that includes a diluent inlet 312, a macro-ingredient sweetener inlet 314, and a target 310. The diluent inlet 312 and the macro-ingredient sweetener inlet 314 are in fluid communication with the target 310 to flow diluent or a combination of diluent and macro-ingredient sweetener down the target 310.

The still water flow path 110 and the carbonated water flow path 120 are fluidically coupled to the diluent inlet 312 of the dispenser nozzle 300, such as via a T-connection. Moreover, a macro-ingredient sweetener is fluidically coupled to the macro-ingredient sweetener inlet 314 of the dispenser nozzle 300.

Each of the micro-ingredient outlets and the macro-ingredient outlets on the injector ring assembly 302 are positioned and angled to promote shooting a stream of micro-ingredients 142 and/or macro-ingredients 132 from the injector ring assembly 302 to the target 310. Therefore, the micro-ingredients 142 and/or macro-ingredients 132 are air mixed with the diluent or diluent and macro-ingredient sweetener flowing down the target 310. The beverage ingredients flowing from the target 310 continue to mix in the air before being dispensed into a container, such as a cup 400 positioned underneath the nozzle 300.

As described above, the bulk ingredient (e.g., still or carbonated water) flowed through the mixing chamber 200 to produce the mixed flavor ingredient from the plurality of molecular ingredients is also dispensed from the dispenser nozzle 300 to produce a finished beverage that is dispensed in the cup 400. For example, carbonated water (or still water) may be flowed through the mixing chamber 200 to produce the mixed flavor ingredient and carbonated water (or still water) may additionally be flowed through the nozzle 300 to mix with other beverage ingredients (e.g. macro-ingredients and/or micro-ingredients) to produce the finished beverage.

Similarly, different combinations of bulk ingredients may be flowed to the mixing chamber 200 and the dispenser nozzle 300 to produce the finished beverage. For example, still water (or carbonated water) may be flowed through the mixing chamber 200 to produce the mixed flavor ingredient and carbonated water (or still water) may additionally be flowed through the nozzle 300 to mix with other beverage ingredients (e.g. macro-ingredients and/or micro-ingredients) to produce the finished beverage.

Therefore, the volume of the bulk ingredient used within the mixing chamber 200 to create the mixed flavor ingredient is less than the total volume of the bulk ingredient needed to dispense the finished beverage.

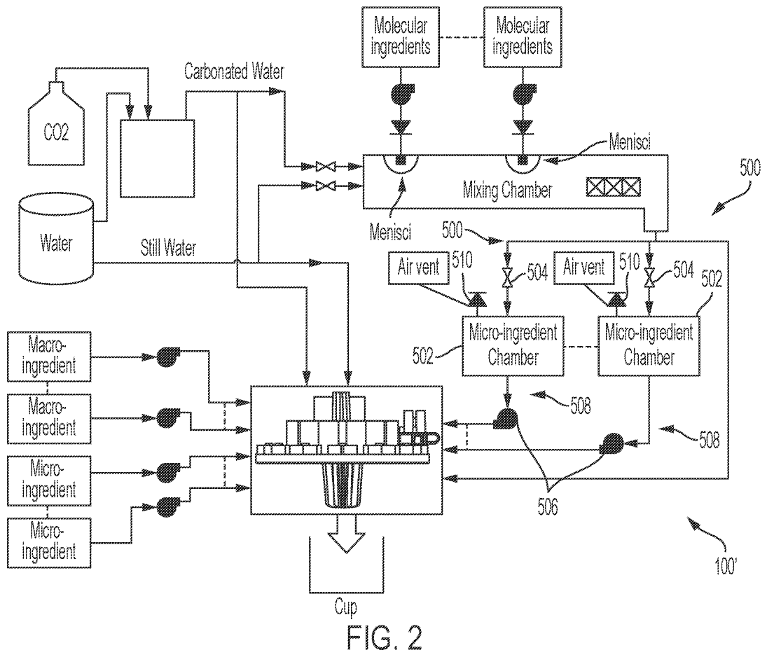

FIG. 2 shows a beverage dispenser, according to another implementation. The beverage dispenser 100′ of FIG. 2 is the same as that of FIG. 1, except for the elements labeled and described in this section. Therefore, like numerals represent like parts and the description of common components is provided above in the description of FIG. 1.

As shown in FIG. 2, the beverage dispenser 100′ is configured for continuous dispensing operation. The various ingredients may be dispensed by the beverage dispenser 100′ in a continuous pour mode where the appropriate ingredients are dispensed in the appropriate proportions (e.g., in a predetermined ratio) for a given flow rate of the beverage being dispensed. In other words, as opposed to a conventional batch operation where a predetermined amount of ingredients are combined for a predetermined volume of beverage, the beverage dispenser 100′ provides for continuous mixing and flows in the correct ratio of ingredients for a pour of any volume. This continuous mix and flow method can also be applied to the dispensing of a particular size beverage selected by the selection of a beverage size button by setting a predetermined dispensing time for each size of beverage.

Beverage dispenser 100′ includes a plurality of mixed flavor ingredient flow paths 500. The mixed flavor ingredient flow paths 500 are in fluid communication with the outlet 208 of the mixing chamber 200 for receiving mixed flavor ingredients produced in the mixing chamber 200. The mixed flavor ingredient flow paths 500 are each in fluid communication with an inlet of a corresponding one of mixed flavor ingredient storage chambers 502 (shown as “Micro-ingredient chamber” in FIG. 2). The mixed flavor ingredient storage chambers 502 receive and store mixed flavor ingredients produced in the mixing chamber 200.

In some implementations, one of the mixed flavor ingredient flow paths 500 is in direct fluid communication with the dispenser nozzle 300 (e.g. without first passing through one of the mixed flavor ingredient storage chambers 502), such as described above with reference to FIG. 1.

A shutoff valve 504 may be positioned along each of the mixed flavor ingredient flow paths 500 at the inlet to each of the mixed flavor ingredient storage chambers 502. Therefore, each of the mixed flavor ingredient storage chambers 502 is individually selectable for receiving mixed flavor ingredients from the mixing chamber 200. In various implementations, a different mixed flavor ingredient may be stored in each of the mixed flavor ingredient storage chambers 502. In some implementations, for higher throughput ingredients, more than one of the mixed flavor ingredient storage chambers 502 may include the same mixed flavor ingredient.

Each mixed flavor ingredient storage chamber 502 also has an outlet to a flow path 508 in fluid communication with an inlet of the dispenser nozzle 300 (e.g., micro-ingredient inlet 304). A pump 506 is positioned along the flow path 508. In some implementations, the plurality of mixed flavor ingredient storage chambers 502 includes micro-ingredients mixed from the molecular ingredients. In some implementations, one or more of the plurality of mixed flavor ingredient storage chambers 502 includes a macro-ingredient.

In use, a mixed flavor ingredient is formed from a bulk ingredient and molecular ingredients mixing in the mixing chamber 200. The mixed flavor ingredient is dispensed from the outlet 208 of the mixing chamber 200 and flows into one of the plurality of mixed flavor ingredient storage chambers 502 with an open shutoff valve 504. In a beverage dispensing operation, mixed flavor ingredient from one or more of the mixed flavor ingredient storage chambers 502 is dispensed (e.g., via pump 506) to the dispenser nozzle and mixed with one or more of a diluent, micro-ingredient, macro-ingredient, or macro-ingredient sweetener to produce a finished beverage.

In some implementations, a low level sensor is positioned proximate to the outlet of the mixed flavor ingredient storage chambers 502 for indicating a low level of ingredients therein. In some implementations, a high-level sensor is positioned proximate to the inlet of the mixed flavor ingredient storage chambers 502 for indicating that the mixed flavor ingredient storage chambers 502 is full. Upon an indication of a low level of ingredients from the low-level sensor, the beverage dispenser 100′ operates the mixing chamber 200 to produce a mixed flavor ingredient for refilling the mixed flavor ingredient storage chambers 502. As such a corresponding shutoff valve 504 is opened and the beverage dispenser 100′ continues to operate until the high level sensor indicates that the mixed flavor ingredient storage chamber 502 is full. For example, a bulk ingredient such as still water source 112 and one or more molecular ingredients 226 may be mixed in the mixing chamber 200 to form a mixed flavor ingredient (e.g., a micro-ingredient), which is dispensed and stored into a mixed flavor ingredient storage chamber 502. The process would continue until the high level sensor indicates that the mixed flavor ingredient storage chamber 502 is full. The high level sensor may be positioned so that the mixing chamber 200 may undergo the wash and/or purge operations described above without overflowing. As the mixed flavor ingredient storage chambers 502 is refilled, air within the chamber is purged via an air vent 510. For example, the air vent 510 may simply be a check valve biased to permit air flow out of the mixed flavor ingredient storage chambers 502 as it is refilled. In some implementations, the air vent 510 may be a shut-off valve that is opened during the refill operation and during normal dispensing operations.

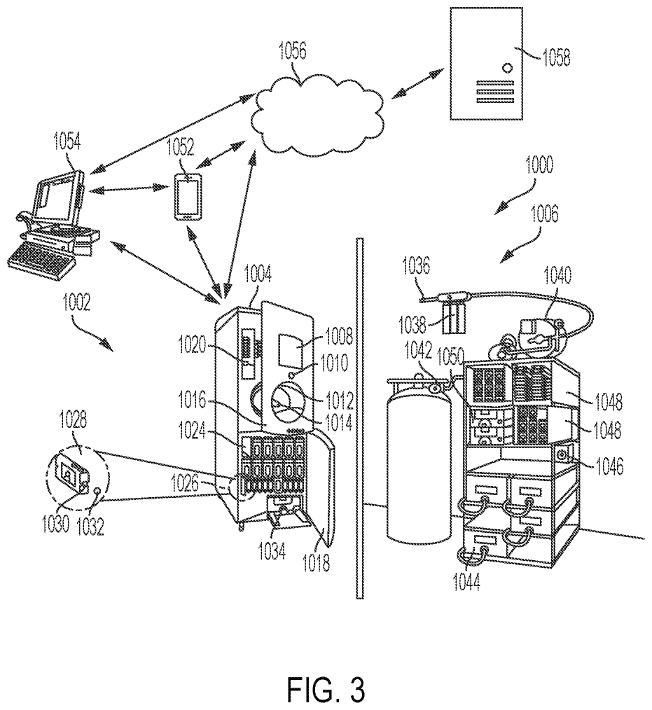

FIG. 3 illustrates an exemplary beverage dispenser system 1000 suitable for implementing the several embodiments of the disclosure. As shown, the beverage dispenser system 1000 is configured as an ice cooled beverage dispenser. Other configurations of beverage dispensers are contemplated by this disclosure such as a drop-in ice-cooled beverage dispenser, a counter electric beverage dispenser, a remote recirculation beverage dispenser, or any other beverage dispenser configuration.

The beverage dispenser system 1000 includes a front room system 1002 with a beverage dispenser 1004 and a back room system 1006. The beverage dispenser 1004 includes a user interface 1008, such as a touchscreen display, to facilitate selection of the beverage to be dispensed. The user interface 1008 may employ various screens to facilitate user interactions on the beverage dispenser 1004 and/or receive a user profile through interaction with a user's mobile device 1052, such as described in commonly owned U.S. patent application Ser. No. 14/485,826, entitled “Product Categorization User Interface for a Dispensing Device,” which is herein incorporated by reference in its entirety.

Upon receiving a beverage selection via the user interface 1008, a pour button 1010 may be activated to dispense the selected beverage from the beverage dispenser 1004 via a nozzle 1012. For example, the pour button 1010 may be an electromechanical button, capacitive touch button, or other button selectable by a user to activate the beverage dispenser 1004 to dispense a beverage. While shown as a button, the pour button 1010 may alternatively be implemented as a lever or other mechanism for activating the beverage dispenser 1004 to dispense a beverage. As shown in FIG. 3, the pour button 1010 is separate from the user interface 1008. In some implementations, the pour button 1010 may be implemented as a selectable icon in the user interface 1008.

In some implementations, the beverage dispenser may also include an ice lever 1014. Upon being activated, the ice lever 1014 may cause the beverage dispenser 1004 to dispense ice through an ice chute (not shown). For beverage dispensers that do not have an ice bin, such as counter-electric or remote recirculation beverage dispensers, the ice lever 1014 may be omitted.

The beverage dispenser 1004 may be secured via a primary door 1016 and an ingredient door 1018. The primary door 1016 and the ingredient door 1018 may be secured via one or more locks. In some implementations, the locks are a lock and key. In some implementations, the lock on the ingredient door 1018 may be opened via an RFID reader (not shown) reading an authorize ingredient package 1028. The primary door 1016 may secure electronic components of the beverage dispenser 1004 including one or more controllers 1020. The ingredient door 1018 may secure an ingredient compartment that houses an ingredient matrix 1024.

The ingredient matrix 1024 includes a plurality of slots 1026 for receiving ingredient packages 1028. In various implementations, the ingredient packages 1028 may be micro-ingredient cartridges. The micro-ingredient cartridges may be single cartridges or double cartridges, such as described in commonly owned U.S. patent application Ser. No. 14/209,684, entitled “Beverage Dispenser Container and Carton,” and U.S. patent application Ser. No. 12/494,427, entitled “Container Filling Systems and Methods,” which are both herein incorporated by reference in their entirety. As shown in FIG. 3, there are three drawers of ingredients in the ingredient matrix 1024. One or more of the drawers may slide back and forth along a rail so as to periodically agitate the ingredients housed on the drawer. Other configurations of the ingredient matrix 1024 are possible, such as via one or more static and/or agitated ingredient towers.

Each ingredient package 1028 may comprise an RFID tag, a fitment 1030, and a fitment seal 1032. The fitment seal 1032 may be removed prior to installation into the beverage dispenser 1004. Upon installation, the fitment 1030 may engage with and provide a fluidic communication between a probe (not shown) in the slot 1026 and the ingredients contained in the ingredient package 1028. The ingredient matrix 1024 may also contain one or more large volume micro-ingredient packages 1034, such as for one or more micro-ingredient sweetener sources.

The beverage dispenser 1004 may also include a carbonator (not shown) for receiving water and carbon dioxide to produce carbonated water. The beverage dispenser 1004 may also include one or more heat exchangers (not shown), such as a cold plate, for cooling one or more of the beverage ingredients contained in or received by the beverage dispenser 1004. In some implementations, one or more of the micro-ingredients dispensed via the nozzle 1012 are not cooled via the heat exchanger or are otherwise maintained at an ambient temperature. Macro-ingredients dispensed via the nozzle 1012 are typically cooled via the heat exchanger prior to being dispensed.

The back room system 1006 is typically located in a back room remote from the front room system 1002, such as a storage area in a merchant location. The back room system 1006 includes a water source 1036 such as a municipal water supply that provides a pressurized source of plain water. The water received via the water source 1036 may be filtered or otherwise treated by a water treatment system 1038. The treated water may optionally be pressurized to a desired pressure with a water booster 1040 and supplied to the beverage dispenser. A carbon dioxide source 1042 may supply carbon dioxide to the beverage dispenser 1004.

One or more macro-ingredient sources 1044 may be located in the back room. The macro-ingredient from each macro-ingredient source 1044 may be supplied to the beverage dispenser 1004 via a pump 1046. The pump 1046 may be a controlled gear pump, diaphragm pump, BIB pump, or any other suitable pump for supplying macro-ingredients to the beverage dispenser 1004. The back room system 1006 may also include a rack with one or more storage locations 1048 for spare micro-ingredients and one or more storage locations 550 for spare macro-ingredients.

The beverage dispenser 1004 may include one or more network interfaces for communicating directly with devices in the front room or the back room, communicating with devices in the front room or the back room in a local area network (LAN), or communicating with devices remote from a location with the beverage dispenser system 1000 via a wide area network (WAN) connection. For example, the beverage dispenser 1004 may include networking devices such as a near field communication (NFC) module, a BLUETOOTH module, a WiFi module, a cellular modem, an Ethernet module, and the like. The beverage dispenser 1004 may communicate via a direct communication or via a LAN with a user's mobile device 1052 or a point-of-sale (POS) device 1054 to receive a beverage selection or user profile of a user for configuring the beverage dispenser 1004 to dispense one or more beverages based on the beverage selection or user profile. The user profile may include stored favorite beverages for the user, mixed or blended beverages created or stored by the user in their profile, and/or one or more beverage preferences, such as preferred nutritive level. The beverage dispenser 1004 may also communicate via a WAN 1056 for communicating with one or more remote servers 1058 to receive software updates, content updates, user profiles, or beverage selections made via the remote server 1058.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A beverage dispenser, comprising:
a bulk ingredient flow path;
a mixing chamber comprising:
an inlet on a first end of the mixing chamber coupled to the bulk ingredient flow path,
an outlet on a second end of the mixing chamber opposite to the first end, and
a sidewall defining a mixing chamber flow path through the mixing chamber from the first end to the second end, wherein a plurality of flavor ingredient nozzles are positioned on the sidewall and adapted to dispense fractional drops of flavor ingredients in the mixing chamber flow path,
a dispenser nozzle comprising a first inlet coupled to the bulk ingredient flow path and a second inlet coupled to the outlet of the mixing chamber.

2. The beverage dispenser of claim 1, wherein the plurality of flavor ingredient nozzles are positioned on the sidewall such that a flow of fluid through the mixing chamber flow path washes over the plurality of flavor ingredient nozzles.

3. The beverage dispenser of claim 1, wherein the mixing chamber comprises a static mixer positioned in the mixing chamber flow path.

4. The beverage dispenser of claim 1, wherein the dispenser nozzle further comprises a plurality of micro-ingredient inlets and one or more macro-ingredient inlets.

5. The beverage dispenser of claim 1, wherein the bulk ingredient flow path is a carbonated or still water flow path.

6. The beverage dispenser of claim 1, wherein the bulk ingredient flow path is a sweetener flow path.

7. The beverage dispenser of claim 1, further comprising:
a flavor ingredient flow path coupled to each of the plurality of flavor ingredient nozzles, each flavor ingredient flow path comprising a check valve.

8. The beverage dispenser of claim 7, wherein the check valve is positioned at an outlet of the corresponding flavor ingredient nozzle.

9. The beverage dispenser of claim 7, further comprising:
a flavor ingredient source coupled to each of the plurality of flavor ingredient nozzles, the flavor ingredient source containing a flavor ingredient.

10. The beverage dispenser of claim 9, wherein the flavor ingredient comprises flavor ingredients with reconstitution ratios greater than 300:1.

11. The beverage dispenser of claim 1, further comprising:
an ingredient storage chamber selectively coupled between the outlet of the mixing chamber and the second inlet of the dispenser nozzle.

12. The beverage dispenser of claim 1, further comprising:
a plurality of ingredient storage chambers, each selectively coupled between the outlet of the mixing chamber and the second inlet of the dispenser nozzle, wherein the ingredient storage chamber is one of the plurality of ingredient storage chambers.

13. A method of dispensing a beverage, comprising:
flowing a bulk beverage ingredient along a flow path of a mixing chamber;
dispensing an amount including a fractional drop of flavor ingredient from each of a plurality of flavor ingredient nozzles positioned along the flow path in a sidewall of the mixing chamber to produce a mixed flavor ingredient;
dispensing the mixed flavor ingredient from a dispenser nozzle coupled to the mixing chamber; and
dispensing the bulk beverage ingredient from the dispenser nozzle.

14. The method of claim 13, wherein the amount of flavor ingredient dispensed from one of the plurality of flavor ingredient nozzles is different than the amount of flavor ingredient dispensed from another of the plurality of flavor ingredient nozzles.

15. The method of claim 13, wherein the bulk beverage ingredient washes over the plurality of flavor ingredient nozzles.

16. The method of claim 13, further comprising: dispensing one or more micro-ingredient and/or one or more macro-ingredient beverage ingredients from the dispenser nozzle.

17. The method of claim 13, wherein the bulk beverage ingredient is carbonated or still water.

18. The method of claim 13, wherein each of the flavor ingredient nozzles is positioned on a flavor ingredient flow path, wherein each flavor ingredient flow path comprising a check valve, wherein the check valve is positioned at an outlet of the corresponding flavor ingredient nozzle.

19. The method of claim 13, wherein a flavor ingredient source is coupled to each of the flavor ingredient flow paths.

20. The method of claim 13, wherein the flavor ingredient has a reconstitution ratios greater than 300:1.
